(19) United States
(12) Patent Application Publication
(10) Pub. No.: US 2017/0334804 A1
(43) Pub. Date: Nov. 23, 2017

(54) F-18 LABELED TRACER AND METHODS OF MANUFACTURE

(71) Applicant: The General Hospital Corporation, Boston, MA (US)

(72) Inventors: David R. Elmaleh, Newton, MA (US); Timothy m. Shoup, Waltham, MA (US)

(21) Appl. No.: 15/522,545

(22) PCT Filed: Oct. 30, 2015
(86) PCT No.: PCT/US15/58357

§ 371 Date: Apr. 27, 2017

Related U.S. Application Data
(60) Provisional application No. 62/073,120, filed on Oct. 31, 2014.

(51) Int. Cl. C07B 59/00; C07F 9/54

(52) U.S. Cl. CPC C07B 59/004; C07F 9/5442; C07B 2200/05

(57) ABSTRACT

A method of producing a radiofluorinated compound comprising the steps of forming a reaction mixture comprising a reactant having a formula of R—Y and a radiofluorinating agent having a formula of R′—¹⁸F; and contacting the reaction mixture with microwave radiation to achieve a temperature of between 100° C. and 250° C. for a time sufficient to convert at least 10% of the reactant into the radiofluorinated compound having a formula of R—¹⁸F, wherein R is selected from the group consisting of an alkyl (C₁-C₂₀), a cycloalkyl (C₃-C₁₀), an aryl, a heteroaryl, an aralkyl and an alkenyl group (C₂-C₂₀); Y is selected from the group consisting of a sulfonate, a nitro, an acetate and a halogen; and R′ is selected from the group consisting of an alkali metal cation, an alkaline earth metal cation, a transition metal cation, an ammonium cation, and a tetraalkylammonium cation is provided.

### CROSS-REFERENCES TO RELATED APPLICATIONS

The present application is based on, claims priority to, and incorporates herein by reference in its entirety, U.S. Provisional Patent Application No. 62/073,120, filed Oct. 31, 2015, and entitled “F-18 Labeled Tracer and Methods of Manufacture.”

### STATEMENT REGARDING FEDERALLY SPONSORED RESEARCH

Not Applicable.

### BACKGROUND

The present invention relates generally to F-18 labeled tracers and methods of manufacturing such tracers.

Microwave induced chemical activation in the field of radiochemistry is not new and has been reported for the radiofluorination of peptides. For example, U.S. Pat. No. 8,247,534 disclosed synthesis of radiofluorinated peptide using microwave activation technology as well as a few other examples of small molecule labeling. However, utilization of this technology is not widespread due to the existing favorable reaction condition employing Kryptofix 2.2.2 or tetrabutylammonium bicarbonate complexation of ¹⁸F anion under anhydrous conditions for nucleophilic substitution. Radiofluorination is executed in acetonitrile, DMSO, DMF or neat (no solvent) conditions. Temperature, solvents, reaction time and process automation for most reactions results in satisfactory yields (i.e. >20%), which allow the radiolabeled drug to be distributed to area hospitals with imaging facilities in close proximity (up to 100 miles if driving, flying may increase distribution radius). The distribution radius cost may increase with distance. Low yields may allow local use but reduces the distribution radius exponentially while increasing production costs due to cyclotron radiation time, irradiated precursor (e.g., ¹⁸O-enriched water) for ¹⁸F-production from the ¹⁸O(p,n)¹⁸F reaction, cGMP reaction precursor kit and other disposable material used by the cyclotron. Nucleophilic ¹⁸F-substitution reactions of non-activated and low activated aromatic precursors are resistant to exchange under various temperatures and solvents resulting in very low yield which eliminate the possibility of widespread distribution and potential commercialization of agents that exhibit high potential as diagnostics.

4-[¹⁸F]Fluorophenyltriphenylphosphonium ion (FTPP) exhibits optimal characteristics as a PET imaging perfusion tracer due to its significant heart uptake and kinetics. This lipophilic cationic compound is a radiofluorinated analog of tetraphenylphosphonium cation (TPP+) and concentrates in mitochondria having a negative inner transmembrane potential (1-4). The data obtained indicate that FTPP is useful for quantitative in vivo PET measurement of ΔΨm. The values observed agree with that measured with tetraphenylphosphonium in a working Langendorff rat heart model (4). Animal studies in rabbits and monkeys illustrated the valuable use of this agent. Phase I safety, dosimetry and heart pharmacokinetic evaluation of FTPP in normal subjects have been completed.

Needed in the art are improved F-18 labeled tracers and improved methods for producing such F-18 labeled tracers (e.g., nucleophile substitution of aromatic compounds) with high yields.

### BRIEF SUMMARY

The present invention provides a method of producing a radiofluorinated compound comprising the steps of forming a reaction mixture comprising a reactant having the formula of R—Y and a radiofluorinating agent having the formula of R′—¹⁸F; and contacting the reaction mixture with microwave radiation to achieve a temperature of between 100° C. and 250° C. for a time sufficient to convert at least 10% of the reactant into the radiofluorinated aromatic compound having the formula of R—¹⁸F F, wherein R is selected from the group consisting of an aryl, a heteroaryl, an aralkyl and an alkenyl group (C₂-C₂₀); Y is selected from the group consisting of a sulfonate, a nitro, an acetate and a halogen; and R′ is selected from the group consisting of an alkali metal cation, an alkaline earth metal cation, a transition metal cation, an ammonium cation, and a tetraalkylammonium cation is provided.

The present disclosure also provides method for producing a radiohalogenated compound having the formula of

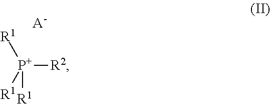

wherein R¹ represents independently for each occurrence aryl or heteroaryl; R² is halogen-substituted aryl, halogen-substituted aralkyl, halogen-substituted alkenyl (C₂-C₂₀); wherein said halogen substituent is fluoride that comprises ¹⁸F, or said halogen substituent is iodide that comprises ¹²³I, ¹²⁴I, ¹²⁵I, or ¹³¹I; and A is an anion that has an overall charge of −1, comprising the steps of obtaining a reactant and a radiohalogenating agent; forming a reaction mixture comprising the reactant and the radiohalogenating agent; and contacting the reaction mixture with microwave radiation to achieve a temperature of between 100° C. and 250° C. for a time sufficient to convert at least 10% of the reactant into the desired radiohalogenated compound.

In one specific embodiment, A is not a halogen anion.

In some embodiments of the present method, when a halogen anion is involved, one additional step is needed to exchange the halogen anion with another anion before the microwave reaction. Specifically, the halogen anion would be completely removed so that it would interfere with the radiofluorine exchange step.

The foregoing and other aspects and advantages of the invention will appear from the following description. In the description, reference is made to the accompanying drawings which form a part hereof, and in which there is shown by way of illustration a preferred embodiment of the invention. Such embodiment does not necessarily represent the full scope of the invention, however, and reference is made therefore to the claims and herein for interpreting the scope of the invention.

### BRIEF DESCRIPTION OF DRAWINGS

The invention will be better understood and features, aspects and advantages other than those set forth above will become apparent when consideration is given to the following detailed description thereof. Such detailed description makes reference to the following drawings.

FIG. 1 shows Patlak analysis of a 21-year-old male. MBF=0.75 ml/minig determined by using the extraction fraction of 0.23 based on animal experimental measurements.

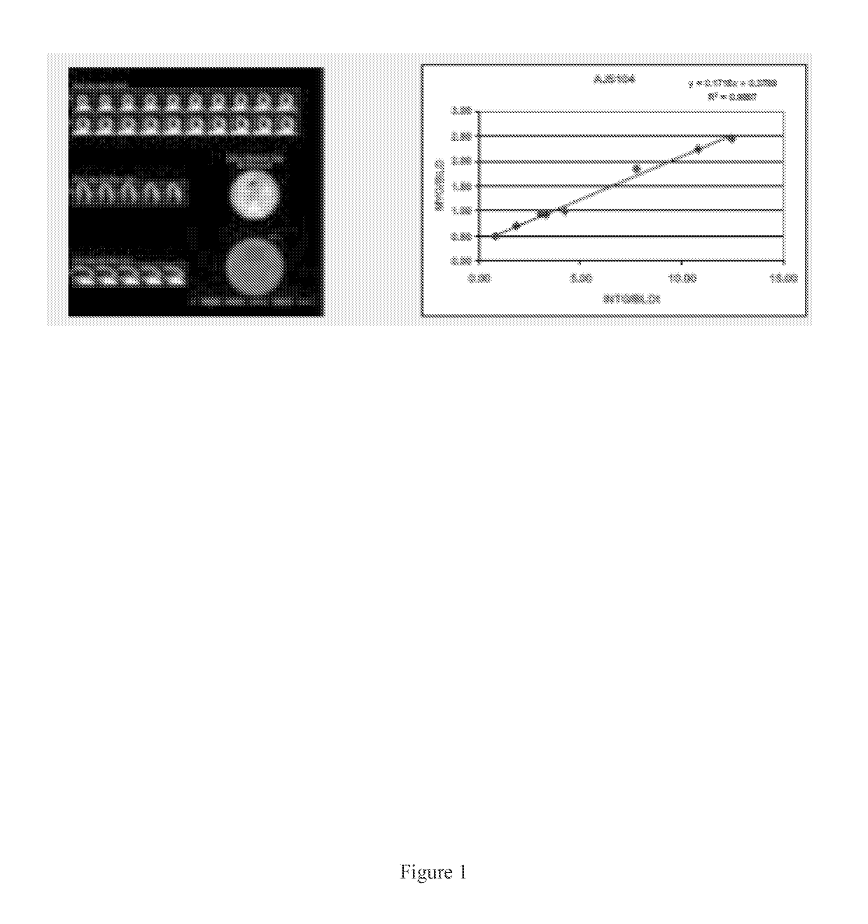

FIG. 2 shows chest pain comparison of CTA, PET and SPECT for a 69 year old female. Left: CTA narrow rate <50%; Conclusion: CAD, LAD stenosis (mild ischemia). Right: Stress MIBI Vs. Stress BEPET indicate advantages of BFPET high resolution.

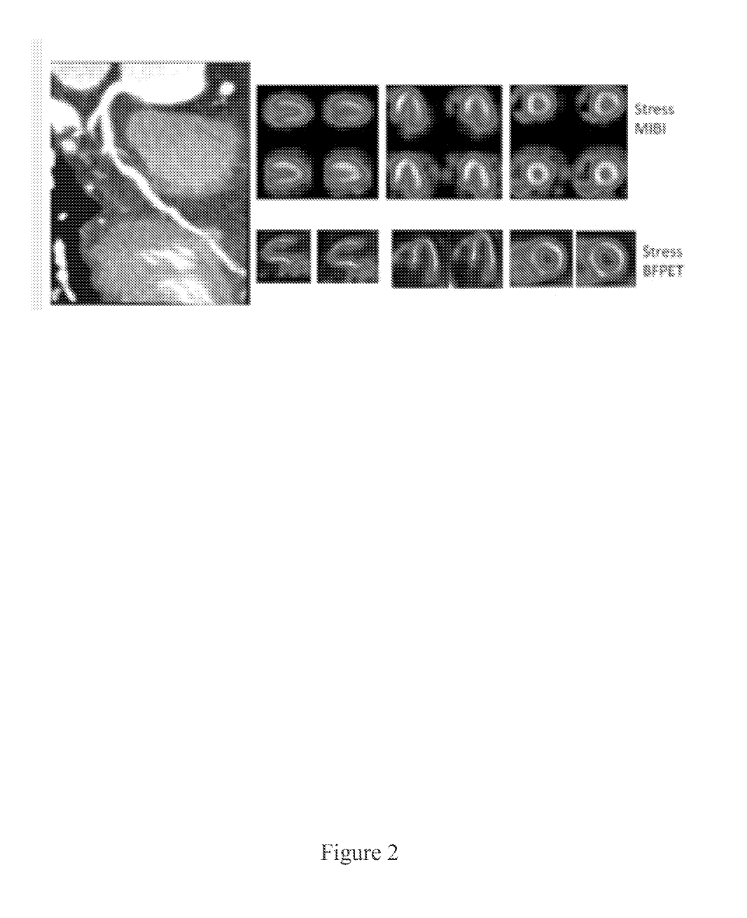

FIG. 3 shows BFPET stress images confirming ischemia in axial, horizontal and vertical camns.

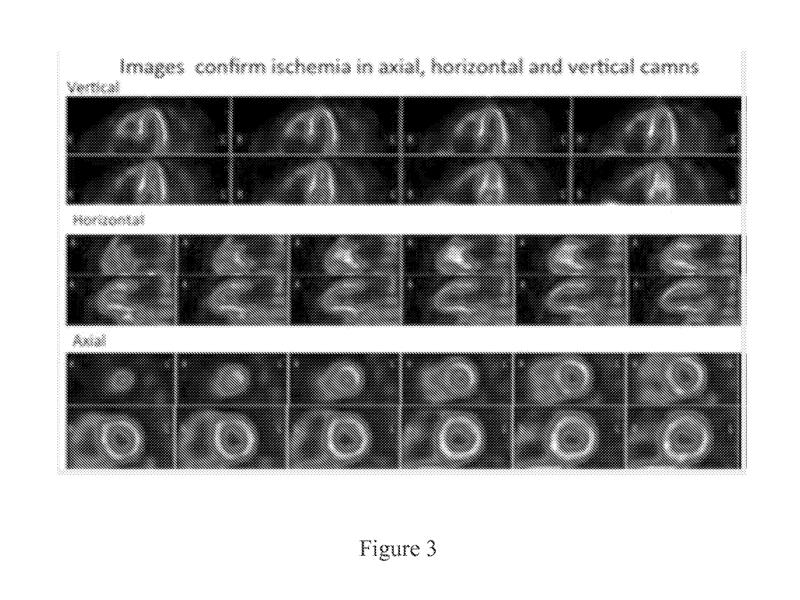

### DETAILED DESCRIPTION

Currently, the known synthetic procedure for FTPP can produce the tracer with a very low yield, thus hindering its potential clinical use. Due to the current difficulties in large scale production of FTPP and other radiolabeled aromatic imaging tracers, improved methods for producing F-18 labeled tracers with high yield are needed. One of the main advantages of such radiolabeled aromatic, venylic or acetylenic compounds is their resistance to difluorination in-vivo.

Definitions

For convenience, certain terms employed in the specification, examples, and appended claims are collected here.

The term “marker,” as used herein, refers to a compound capable of undergoing positron emission radioactive decay, such as a compound comprising or consisting of one or more PET isotopes.

The term “PET tracer” or “tracer,” as used herein, refers to a compound comprising a positron-emitting radioactive isotope. Such a PET tracer may be designed to bind to a particular cell component, e.g. a cell surface receptor, such that detection of signals emitted by the positron-emitting radioactive isotope indicates the location and quantity of that cell component.

The term “positron” or “antielectron,” as used herein, refers to the antiparticle or the antimatter counterpart of the electron. The positron has an electric charge of +1, a spin of ½, and the same mass as an electron. When a low-energy positron collides with a low-energy electron, annihilation occurs, resulting in the production of two or more gamma ray photons. Positrons may be generated by positron emission radioactive decay (through weak interactions), or by pair production from a sufficiently energetic photon.

As used herein, the term “positron emission tomography” or “PET,” refer to a nuclear medicine imaging technique which produces a three-dimensional image or picture of functional processes in the body. The PET scanner detects pairs of gamma rays emitted indirectly by a positron-emitting radionuclide (tracer), which is introduced into the body on a biologically active molecule. Images of tracer concentration in 3-dimensional space within the body are then reconstructed by computer analysis.

The term “detecting,” as used herein, refers to a detecting step carried out by placing the subject in a PET scanner to detect pairs of annihilation photons produced when positrons emitted by ¹⁸F travel up to a few millimeters, and encounter and annihilate an electron. These annihilation photons are the “signals” emitted by the PET tracer.

The term “diagnose” or “diagnosing,” as used herein, refers to methods by which the skilled artisan can estimate and determine whether or not a patient is suffering from a given disease or condition. Diagnostic evaluation may be performed on the basis of one or more diagnostic indicators, such as with a marker, the presence, absence, or the amount of which is indicative of the presence, severity or absence of the disease or condition.

As used herein, the term “patient” refers to any mammal or any warm-blooded animal, such as a mouse, rat, dog, feline, monkey, guinea pig, rabbit, or human, a non-human primate, and the like. Preferably, a patient is a human.

The term “pharmaceutically-acceptable salts,” as used herein, refers to salts commonly used to form alkali metal salts and to form addition salts of free acids or free bases. The nature of the salt may vary, provided that it is pharmaceutically acceptable. Suitable pharmaceutically acceptable acid addition salts of compounds for use in the present methods may be prepared from an inorganic acid or from an organic acid. Non-limiting examples of such inorganic acids are hydrochloric, hydrobromic, hydroiodic, nitric, carbonic, sulfuric and phosphoric acid. Appropriate organic acids may be selected from aliphatic (or alkyl), cycloalkyl, aromatic, arylalkyl, heterocyclic, carboxylic and sulfonic classes of organic acids, non-limiting examples of which are formic, acetic, propionic, succinic, glycolic, gluconic, lactic, malic, tartaric, citric, ascorbic, glucuronic, maleic, fumaric, pyruvic, aspartic, glutamic, benzoic, anthranilic, mesylic, 4-hydroxybenzoic, phenylacetic, mandelic, embonic (pamoic), methanesulfonic, ethanesulfonic, benzenesulfonic, pantothenic, 2-hydroxyethanesulfonic, toluenesulfonic, sulfanilic, cyclohexylaminosulfonic, stearic, algenic, hydroxybutyric, salicylic, galactaric and galacturonic acid. Suitable pharmaceutically-acceptable base addition salts of compounds of use in the present methods include, but are not limited to, metallic salts made from aluminum, calcium, lithium, magnesium, potassium, sodium and zinc or organic salts made from N, NT-dibenzylethylenediamine, chloroprocaine, choline, diethanolamine, ethylenediamine, meglumine-(N-methylglucamine) and procaine. Ascorbic acid may also be used as an excipient. Suitable formulations for each of these methods of administration may be found in, for example, Remington: The Science and Practice of Pharmacy, A. Gennaro, ed., 20th edition, Lippincott, Williams & Wilkins, Philadelphia, Pa. Click Chemistry Method.

The term “leaving group,” as used herein, refers to a functionality which upon bond cleavage departs with an electron pair. In general, good leaving groups are those moieties which are expelled from the substrate as weak bases. For example, sulfates, sulfonates, chloride, bromide, iodide, phosphates and the like are good leaving groups. In addition, some moieties may be good leaving groups when protonated or complexed with a Lewis acid. For example, alkoxide ions are generally poor leaving groups, but alcohols are good leaving groups. It should be noted that ring strain may, in some cases, allow a rather poor leaving group to be expelled, as in the case of epoxides, aziridines, and the like.

The term “protecting group,” as used herein, refers to temporary substituents which protect a potentially reactive functional group from undesired chemical transformations. Examples of such protecting groups include esters of carboxylic acids, silyl ethers of alcohols, and acetals and ketals of aldehydes and ketones, respectively. The field of protecting group chemistry has been reviewed (Greene, T. W.; Wuts, P. G. M. Protective Groups in Organic Synthesis, 2^{nd} ed.; Wiley: New York, 1991). Protected forms of the inventive compounds are included within the scope of this invention.

The term “substituted,” as used herein, refers to all permissible substituents of organic compounds. In a broad aspect, the permissible substituents include acyclic and cyclic, branched and unbranched, carbocyclic and heterocyclic, aromatic and nonaromatic substituents of organic compounds. Illustrative substituents include, for example, those described herein above. The permissible substituents may be one or more and the same or different for appropriate organic compounds. For purposes of this invention, the heteroatoms such as nitrogen may have hydrogen substituents and/or any permissible substituents of organic compounds described herein which satisfy the valences of the heteroatoms. This invention is not intended to be limited in any manner by the permissible substituents of organic compounds.

For purposes of this invention, the chemical elements are identified in accordance with the Periodic Table of the Elements, CAS version, Handbook of Chemistry and Physics, 67th Ed., 1986-87, inside cover.

The term “crown ether,” as used herein, refers to a cyclic molecule in which ether groups (i.e., polyethers) are connected by dimethylene linkages.

The term “heteroatom,” as used herein, refers to an atom of any element other than carbon or hydrogen. Illustrative heteroatoms include boron, nitrogen, oxygen, phosphorus, sulfur and selenium.

The term “alkyl,” as used herein refers to saturated aliphatic groups, including straight-chain alkyl groups, branched-chain alkyl groups, cycloalkyl (alicyclic) groups, alkyl substituted cycloalkyl groups, and cycloalkyl substituted alkyl groups. In certain embodiments, a straight chain or branched chain alkyl has about 30 or fewer carbon atoms in its backbone (e.g., C₁-C₃₀ for straight chain, C₃-C₃₀ for branched chain), and alternatively, about 20 or fewer. Likewise, cycloalkyls have from about 3 to about 10 carbon atoms in their ring structure, and alternatively about 5, 6 or 7 carbons in the ring structure.

Unless the number of carbons is otherwise specified, the term “lower alkyl,” as used herein, refers to an alkyl group, as defined above, but having from one to about ten carbons, alternatively from one to about six carbon atoms in its backbone structure. Likewise, “lower alkenyl” and “lower alkynyl” have similar chain lengths.

The term “aralkyl,” as used herein, refers to an alkyl group substituted with an aryl group (e.g., an aromatic or heteroaromatic group).

The term “cycloalkyl,” as used herein, refers to radicals having three to ten carbon atoms, such as cyclopropyl and cyclobutyl. “Alkylcycloalky” means a cyclized alkyl having from four to about nine ring carbon atoms being substituted with an alkyl group, preferably a lower alkyl group.

The terms “alkenyl” and “alkynyl,” as used herein, refer to unsaturated aliphatic groups analogous in length and possible substitution to the alkyls described above, but that contain at least one double or triple bond respectively. In some embodiments, an alkenyl or alkynyl may have about 30 or fewer carbon atoms in its backbone (e.g., C₂-C₃₀ for straight chain, C₃-C₃₀ for branched chain), and alternatively, about 20 or fewer.

The term “aryl,” as used herein, refers to 5-, 6- and 7-membered single-ring aromatic groups that may include from zero to four heteroatoms, for example, benzene, naphthalene, anthracene, pyrene, pyrrole, furan, thiophene, imidazole, oxazole, thiazole, triazole, pyrazole, pyridine, pyrazine, pyridazine and pyrimidine, and the like. Those aryl groups having heteroatoms in the ring structure may also be referred to as “aryl heterocycles” or “heteroaromatics.” The aromatic ring may be substituted at one or more ring positions with such substituents as described above, for example, halogen, azide, alkyl, aralkyl, alkenyl, alkynyl, cycloalkyl, hydroxyl, alkoxyl, amino, nitro, sulfhydryl, imino, amido, phosphonate, phosphinate, carbonyl, carboxyl, silyl, ether, alkylthio, sulfonyl, sulfonamido, ketone, aldehyde, ester, heterocyclyl, aromatic or heteroaromatic moieties, —CF₃, —CN, or the like. The term “aryl” also includes polycyclic ring systems having two or more cyclic rings in which two or more carbons are common to two adjoining rings (the rings are “fused rings”) wherein at least one of the rings is aromatic, e.g., the other cyclic rings may be cycloalkyls, cycloalkenyls, cycloalkynyls, aryls and/or heterocyclyls.

The terms “ortho,” “meta” and “para,” as used herein refer to 1,2-, 1,3- and 1,4-disubstituted benzenes, respectively. For example, the names 1,2-dimethylbenzene and ortho-dimethylbenzene are synonymous.

The terms “heterocyclyl”, “heteroaryl”, or “heterocyclic group,” as used herein, refer to 3- to about 10-membered ring structures, alternatively 3- to about 7-membered rings, whose ring structures include one to four heteroatoms. Heterocycles may also be polycycles. Heterocyclyl groups include, for example, thiophene, thianthrene, furan, pyran, isobenzofuran, chromene, xanthene, phenoxanthene, pyrrole, imidazole, pyrazole, isothiazole, isoxazole, pyridine, pyrazine, pyrimidine, pyridazine, indolizine, isoindole, indole, indazole, purine, quinolizine, isoquinoline, quinoline, phthalazine, naphthyridine, quinoxaline, quinazoline, cinnoline, pteridine, carbazole, carboline, phenanthridine, acridine, pyrimidine, phenanthroline, phenazine, phenarsazine, phenothiazine, furazan, phenoxazine, pyrrolidine, oxolane, thiolane, oxazole, piperidine, piperazine, morpholine, lactones, lactams such as azetidinones and pyrrolidinones, sultams, sultones, and the like. The heterocyclic ring may be substituted at one or more positions with such substituents as described above, as for example, halogen, alkyl, aralkyl, alkenyl, alkynyl, cycloalkyl, hydroxyl, amino, nitro, sulfhydryl, imino, amido, phosphonate, phosphinate, carbonyl, carboxyl, silyl, ether, alkylthio, sulfonyl, ketone, aldehyde, ester, a heterocyclyl, an aromatic or heteroaromatic moiety, —CF₃, —CN, or the like.

The terms “polycyclyl” or “polycyclic group,” as used herein, refer to two or more rings (e.g., cycloalkyls, cycloalkenyls, cycloalkynyls, aryls and/or heterocyclyls) in which two or more carbons are common to two adjoining rings, e.g., the rings are “fused rings”. Rings that are joined through non-adjacent atoms are termed “bridged” rings. Each of the rings of the polycycle may be substituted with such substituents as described above, as for example, halogen, alkyl, aralkyl, alkenyl, alkynyl, cycloalkyl, hydroxyl, amino, nitro, sulfhydryl, imino, amido, phosphonate, phosphinate, carbonyl, carboxyl, silyl, ether, alkylthio, sulfonyl, ketone, aldehyde, ester, a heterocyclyl, an aromatic or heteroaromatic moiety, —CF₃, —CN, or the like.

The term “carbocycle,” as used herein, refers to an aromatic or non-aromatic ring in which each atom of the ring is carbon.

The term “nitro,” as used herein, refers to —NO₂; the term “halogen,” as used herein, refers to —F, —Cl, —Br or —I; the term “sulfhydryl,” as used herein refers to —SH; the term “hydroxyl,” as used herein, refers to —OH; and the term “sulfonyl,” as used herein, refers to —SO₂⁻. The term “Halide,” as used herein, refers to the corresponding anion of the halogens, and the term “pseudohalide,” as used herein, has the definition set forth on 560 of “Advanced Inorganic Chemistry” by Cotton and Wilkinson.

The terms “amine” and “amino,” as used herein, refer to both unsubstituted and substituted amines, e.g., a moiety that may be represented by the general formulas —N(R₁₀R₁₁) or —N+(R₁₀R₁₁R₁₂), wherein R₁₀, R₁₁ and R₁₂ each independently represent a hydrogen, an alkyl, an alkenyl, —(CH₂)ₘ—R₂₁, or R₁₀ and R₁₁, taken together with the N atom to which they are attached complete a heterocycle having from 4 to 8 atoms in the ring structure; R₂₁ represents an aryl, a cycloalkyl, a cycloalkenyl, a heterocycle or a polycycle; and m is zero or an integer in the range of 1 to 8. In other embodiments, R₁₀ and R₁₁ (and optionally R₁₂) each independently represent a hydrogen, an alkyl, an alkenyl, or —(CH₂)ₘ—R₂₁. Thus, the term “alkylamine” includes an amine group, as defined above, having a substituted or unsubstituted alkyl attached thereto, i.e., at least one of R₁₀ and R₁₁ is an alkyl group.

The term “acylamino,” as used herein, refers to a moiety that may be represented by the general formula —NR₁₀COR₁₄, wherein R₁₀ is as defined above, and R₁₄ represents a hydrogen, an alkyl, an alkenyl or —(CH₂)ₘ—R₂₁, where m and R₂₁ are as defined above.

The term “amido,” as used herein, refers to an amino-substituted carbonyl and includes a moiety that may be represented by the general formula —CONR₁₀R₂₂, wherein R₁₀ and R₁₁ are as defined above. In certain embodiments, the amide in the present invention may include either stable or unstable imides. In some embodiments, the amide in the present invention may not include unstable imides.

The term “alkylthio,” as used herein, refers to an alkyl group, as defined above, having a sulfur radical attached thereto. In certain embodiments, the “alkylthio” moiety is represented by one of —S-alkyl, —S-alkenyl, —S-alkynyl, and —S—(CH₂)ₘ—R₂₁, wherein m and R₂₁ are defined above. Representative alkylthio groups may include methylthio, ethyl thio, and the like.

The term “carboxyl,” as used herein, refers to such moieties as may be represented by the general formulas —COXR₁₅ or —XCOR₁₆, wherein X is a bond or represents an oxygen or a sulfur, and R₁₅ and R₁₆ represents a hydrogen, an alkyl, an alkenyl, —(CH₂)ₘ—R₂₁ or a pharmaceutically acceptable salt, R₁₆ represents a hydrogen, an alkyl, an alkenyl or —(CH₂)ₘ—R₂₁, where m and R₂₁ are defined above. Where X is an oxygen and R₁₅ or R₁₆ is not hydrogen, the formula represents an “ester”. Where X is an oxygen, and R₁₅ is as defined above, the moiety is referred to herein as a carboxyl group, and particularly when R₁₅ is a hydrogen, the formula represents a “carboxylic acid”. Where X is an oxygen, and R₁₆ is hydrogen, the formula represents a “formate”. In general, where the oxygen atom of the above formula is replaced by sulfur, the formula represents a “thiolcarbonyl” group. Where X is a sulfur and R₁₅ or R₁₆ is not hydrogen, the formula represents a “thiolester.” Where X is a sulfur and R₁₅ is hydrogen, the formula represents a “thiolcarboxylic acid.” Where X is a sulfur and R₁₆ is hydrogen, the formula represents a “thiolformate.” On the other hand, where X is a bond, and R₁₅ is not hydrogen, the above formula represents a “ketone” group. Where X is a bond, and R₁₅ is hydrogen, the above formula represents an “aldehyde” group.

The term “carbamoyl,” as used herein, refers to —O(C═O)NRR′, where R and R′ are independently H, aliphatic groups, aryl groups or heteroaryl groups.

The terms “oxime” and “oxime ether,” as used herein, refer to moieties that may be represented by the general formula —CR₃₅═N—OR, wherein R₃₅ is hydrogen, alkyl, cycloalkyl, alkenyl, alkynyl, aryl, aralkyl, or —(CH₂)ₘ—R₂₁. The moiety is an “oxime” when R is H; and it is an “oxime ether” when R is alkyl, cycloalkyl, alkenyl, alkynyl, aryl, aralkyl, or —(CH₂)ₘ—R₂₁.

The term “oxo,” as used herein, refers to a carbonyl oxygen (═O).

The terms “alkoxyl” or “alkoxy,” as used herein, refer to an alkyl group, as defined above, having an oxygen radical attached thereto. Representative alkoxyl groups include methoxy, ethoxy, propyloxy, tert-butoxy and the like. An “ether” is two hydrocarbons covalently linked by an oxygen. Accordingly, the substituent of an alkyl that renders that alkyl an ether is or resembles an alkoxyl, such as may be represented by one of —O-alkyl, —O-alkenyl, —O-alkynyl, —O—(CH₂)ₘ—R₂₁, where m and R₂₁ are described above.

The term “sulfonate,” as used herein, refers to a moiety that may be represented by the general formula —SO₂—OR₁₇, which R₁₇ is an electron pair, hydrogen, alkyl, cycloalkyl, or aryl.

The term “sulfate,” as used herein, refers to a moiety that may be represented by the general formula —O—SO₂—OR₁₇, wherein R₁₇ is as defined above.

The term “sulfonamido,” as used herein, refers to a moiety that may be represented by the general formula —NR₁₀—SO₂—OR₁₆, wherein R₁₀ and R₁₆ are as defined above.

The term “sulfamoyl,” as used herein, refers to a moiety that may be represented by the general formula —SO₂—NR₁₀R₁₁, wherein R₁₀ and R₁₁ are as defined above.

The term “sulfonyl,” as used herein, refers to a moiety that may be represented by the general formula —SO₂R₁₈, wherein R₁₈ is one of the following: hydrogen, alkyl, alkenyl, alkynyl, cycloalkyl, heterocyclyl, aryl or heteroaryl.

The term “sulfoxido,” as used herein, refers to a moiety that may be represented by the general formula —SOR₁₈, wherein R₁₈ is defined above.

Analogous substitutions may be made to alkenyl and alkynyl groups to produce, for example, aminoalkenyls, aminoalkynyls, amidoalkenyls, amidoalkynyls, iminoalkenyls, iminoalkynyls, thioalkenyls, thioalkynyls, carbonyl-substituted alkenyls or alkynyls.

The definition of each expression, e.g., alkyl, m, n, and the like, when it occurs more than once in any structure, is intended to be independent of its definition elsewhere in the same structure.

The terms triflyl, tosyl, mesyl, and nonaflyl are art-recognized and refer to trifluoromethanesulfonyl, p-toluenesulfonyl, methanesulfonyl, and nonafluorobutanesulfonyl groups, respectively. The terms triflate, tosylate, mesylate, and nonaflate are art-recognized and refer to trifluoromethanesulfonate ester, p-toluenesulfonate ester, methanesulfonate ester, and nonafluorobutanesulfonate ester functional groups and molecules that contain said groups, respectively.

The abbreviations Me, Et, Ph, Tf, Nf, Ts, and Ms represent methyl, ethyl, phenyl, trifluoromethanesulfonyl, nonafluorobutanesulfonyl, p-toluenesulfonyl and methanesulfonyl, respectively. A more comprehensive list of the abbreviations utilized by organic chemists of ordinary skill in the art appears in the first issue of each volume of the Journal of Organic Chemistry; this list is typically presented in a table entitled Standard List of Abbreviations.

The term “halogenation,” as used herein, refers to a chemical reaction that involves the reaction of a compound with a radionuclide-halogen and results in the halogen being added to the compound. The term “radiohalogenation,” as used herein, refers to chemical reaction that involves the reaction of a compound with a radionuclide-halogen, such as the positron-emitting radioactive-halogen isotope and results in the radioactive halogen being added to the compound.

The term “radiohalogenating agent,” as used herein, refers to any compound or substance that can provide radioactive-halogens, such as the positron-emitting radioactive-halogen isotope.

For example, a radiofluorinating agent may include any compound or substance that can provide radio-active fluoride, i.e., ¹⁸F.

The Invention

In one aspect, the present invention discloses a method for making radiohalogenated compounds, e.g., as imaging tracers. Applicants' previous patent and applications (such as US 2005/0260130, U.S. Pat. No. 7,632,485 and EP 2610234) disclosed organic synthesis methods for preparing radiofluorinated substituted alkyl, cycloalkyl, aryl, and alkenyl compounds. Specifically, these previous patents and applications disclose a catalytic radiohalogenation reaction that involves reacting anhydrous potassium halide, a crown ether, and an organic compound that has a leaving group. Those methods required the use of a crown ether such as Kryptofix 2.2.2. The yields of the radiohalogenated compounds in those methods were usually low (less than 10%).

Applicants here disclose a microwave-assisted synthetic method that can significantly improve the overall yield of radiohalogenated compounds.

In one aspect, the present method is applicable to make a compound represented by formula of R—¹⁸F , wherein R is selected from the group consisting of an aryl, a heteroaryl, an aralkyl and an alkenyl group. Applicants' previous patent and applications (such as US 2005/0260130, U.S. Pat. No. 7,632,485 and EP 2610234) disclose many examples of radiohalogenated compounds that may be produced by using the present method.

In one aspect, a method of producing a radiofluorinated compound comprising the steps of a) forming a reaction mixture comprising a reactant having a formula of R—Y and a radiofluorinating agent having a formula of R′—¹⁸F; and b) contacting the reaction mixture with microwave radiation to achieve a temperature of between 100° C. and 250° C. for a time sufficient to convert at least 10% of the reactant into at least one desired radiofluorinated compound having the formula of R—¹⁸F,
wherein
R is selected from the group consisting of an aryl, a heteroaryl, an aralkyl and an alkenyl group (C₂-C₂₀);
Y is selected from the group consisting of a sulfonate, a nitro, an acetate and a halogen; and
R′ is selected from the group consisting of an alkali metal cation, an alkaline earth metal cation, a transition metal cation, an ammonium cation, and a tetraalkylammonium cation.

In one embodiment, R is an aryl group or a heteroaryl group.

In one embodiment, R is an aryl group.

In one embodiment, R is an aryl group having the formula of

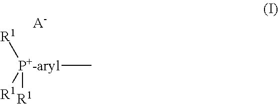

wherein
R¹ represents independently for each occurrence aryl or heteroaryl; and
A is an anion that has an overall charge of −1.

In some embodiments, A is an anion selected from the group consisting of an acetate, a nitrate, a sulfonate, PO₄M₂ (M is a metal, such as an alkali metal), a valerate, an oleate, a palmitate, a stearate, a laurate, and a benzoate.

In some embodiments, A is an anion selected from the group consisting of an acetate and a nitrate.

In one specific embodiment, A is not a halogen anion.

In some embodiments of the present method, when a halogen anion is involved, one additional step is needed to exchange the halogen anion with another anion before the microwave reaction. Specifically, the halogen anion would be completely removed so that it would interfere with the radiofluorine exchange step.

In one specific embodiment, R¹ is a phenyl group and A is a nitrate group.

In one embodiment, Y in the reactant is selected from the group consisting of a nitro, an acetate, a halogen or any other electron withdrawing group vulnerable to nucleophilic substitution.

In one specific embodiment, Y in the reactant is a nitro group.

In some embodiments, R′ in the radiofluorinating agent is either an ammonium cation or a tetraalkylammonium cation. In one specific embodiment, R′ is an ammonium cation.

The Example shows an example of a reactant and method for producing the reactant. Applicants' previous patents and applications (such as US 2005/0260130, U.S. Pat. No, 7,632,485 and EP 2610234) disclose additional examples of reactants and methods of making the reactants. Applicants envision that a reactant may be produced by any suitable method as appreciated by one skilled in the art.

A radiofluorinating agent may include any compound or substance that can produce radio-active fluoride, i.e., ¹⁸F. In one embodiment, the radiofluorinating agent may be a ¹⁸F salt with a cation selected from the group consisting of an alkali metal cation, an alkaline earth metal cation, a transition metal cation, an ammonium cation, and a tetraalkylammonium cation. In one embodiment, the radiofluorinating agent may be a ¹⁸F salt with a cation selected from the group consisting of an alkali metal cation, an ammonium cation, and a tetraalkylammonium cation. In one embodiment, the radiofluorinating agent may be a ¹⁸F salt with either an alkali metal cation or an ammonium cation. In one specific embodiment, the radiofluorinating agent may be a ¹⁸F salt with an ammonium cation (NH₄¹⁸F).

In some embodiments, the present method may include one additional step of pre-treatment of the reactant and the radiohalogenating agent to remove base before microwave irradiation. As shown in the Example, Applicants determined that radiofluorination of FTPP is sensitive to small amounts of base in the reaction mixture such as Kryptofix 2.2.2 and potassium bicarbonate used for complexation of F-18 anion (Table 1). As well as from the method of ion exchange trap and release of the radiofluoride which introduce trace amounts of base. Heating the reaction mixture in presents of these bases would result in decomposition, thus leading to low labeling yields.

The Example shows an exemplary method of removing base from the reactant and the radiohalogenating agent. For example, a radiohalogenating agent may be treated in an ammonium hydroxide preconditioned cartridge (e.g., Sep-Pak QMA light cartridge; 1% ammonium hydroxide followed by sterile water) and subsequently eluted from the cartridge with 1 mL of a 1% solution of ammonium hydroxide/acetonitrile solution (20:80).

In one embodiment, Applicants note there is a decrease in yield to less than 10% and in most cases 1-2% when using the an unconditioned column. This is because more sodium bicarbonate or potassium carbonate counterion is released from the anion exchange column which decomposes the starting material. Ideally no anion exchange column should be used from trap-and-release of the F-18 anion but this is not practical due to the volume of water from the cyclotron target. In one embodiment, the smallest the anion exchange column works best (i.e., Fluoride MP-1 from MedChem Imaging).

After a reactant and a radiofluorinating agent are obtained, the reactant and the radiofluorinating agent are mixed into a reaction mixture. In some embodiments, the reaction mixture does not include any solvent.

In some embodiments, the reaction mixture may include at least one solvent. For reactions conducted in the presence of the solvent, the solvents may be one or more solvents selected from the group consisting of methanol, ethanol, n-propanol, isopropanol, n-butanol, t-butanol, ethylene glycol, ethylene glycol monomethyl ether, ethylene glycol monoethyl ether, diethylene glycol, diethylene glycol monomethyl ether, propylene glycol, propylene glycol monomethyl ether, propylene glycol monoethyl ether, trimethylene glycol, glycerol, and 1,4-butylene glycol, dimethyl sulfoxide (DMSO), dimethylformamide (DMF), acetonitrile and others. In one embodiment, the solvents may be DMSO.

After the reaction mixture forms, the reaction mixture may contact with microwave irradiation to achieve a sufficient temperature for a time sufficient to convert at least 10% of the reactant into at least one desired radiofluorinated compound.

In one embodiment, the temperature is between 100° C. and 250° C. In one embodiment, the temperature is between 120° C. and 220° C. In one embodiment, the temperature is between 140° C. and 210° C. In one embodiment, the temperature is between 150° C. and 190° C. In one preferred embodiment, the temperature is between 160° C. and 180° C. In one more preferred embodiment, the temperature is about 170° C.

In one embodiment, the reaction mixture and microwave irradiation are performed in a closed pressure resistant vessel.

In one embodiment, the reaction mixture is treated under microwave irradiation at the mentioned temperatures for 2-5 minutes.

In one embodiment of the present invention, microwave irradiation and high temperatures are used. Water or acetonitrile due to its evaporability,would not interfere in the anhydrous profile of the reaction mixture.

In one embodiment, the reaction time of the present microwave-assisting method is significantly less than that in the catalytic radiofluorination as previously reported (such as US 2005/0260130, U.S. Pat. No. 7,632,485 and EP 2610234). For example, in one embodiment, the reaction time is less than 10 minutes. In some embodiment, the reaction time is less than 5 minutes. In one preferred embodiment, the reaction time is about 2 minutes.

In one embodiment, the present method may include additional step of purification. Applicants envision that any purification method as appreciated by one skilled in the art may be used in the present invention. In one specific embodiment, the purification step uses a high-performance liquid chromatography (HPLC) method. The Example shows the detail information of HPLC purification.

In some embodiments, the present method significantly increases the yields of the radiofluorinated compound.

In one embodiment, the yield of the radiofluorinated compound is at least 10%.

In one embodiment, the yield of the radiofluorinated compound is at least 15%.

In one embodiment, the yield of the radiofluorinated compound is at least 20%.

In one embodiment, the yield of the radiohalogenated compound is at least 30%.

In one embodiment, the yield of the radiohalogenated compound is at least 40%.

In one embodiment, the yield of the radiohalogenated compound is at least 50%.

Although a radiofluorinated compound was used as an example, Applicants envision that the present method is applicable to make any radiohalogenated compound.

In one aspect, the present method is applicable to make a compound represented by formula II:

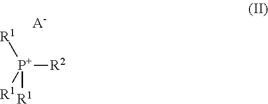

wherein
R¹ represents independently for each occurrence aryl or heteroaryl;
R² is halogen-substituted aryl, halogen substituted aralkyl, halogen-substituted alkenyl (C₂-C₂₀); wherein said halogen substituent is fluoride that comprises ¹⁸F, or said halogen substituent is iodide that comprises ¹²³I, ¹²⁴I, ¹²⁵I, or ¹³¹I; and
A is an anion that has an overall charge of −1.

In certain embodiments, the present invention relates to compound II, wherein the halogen substituent of R² is fluoride that comprises ¹⁸F; and the compound has a radioactivity of greater than or equal to about 1 Curie/mmol.

In certain embodiments, the present invention relates to compound II, wherein the halogen substituent of R² is fluoride that comprises ¹⁸F; and the compound has a radioactivity of greater than or equal to about 5 Curie/mmol.

In certain embodiments, the present invention relates to compound II, wherein the halogen substituent of R² is fluoride that comprises ¹⁸F; and the compound has a radioactivity of greater than or equal to about 10 Curie/mmol.

In certain embodiments, the present invention relates to compound II, wherein the halogen substituent of R² is fluoride that comprises ¹⁸F; and the compound has a radioactivity of greater than or equal to about 100 Curie/mmol.

In certain embodiments, the present invention relates to compound II, wherein the halogen substituent of R² is fluoride that comprises ¹⁸F; and the compound has a radioactivity of greater than or equal to about 1,000 Curie/mmol.

In certain embodiments, the present invention relates to compound II, wherein the halogen substituent of R² is iodide that comprises ¹²³I; and the compound has a radioactivity of greater than or equal to about 1 Curie/mmol.

In certain embodiments, the present invention relates to compound II, wherein the halogen substituent of R² is iodide that comprises ¹²³I; and the compound has a radioactivity of greater than or equal to about 5 Curie/mmol.

In certain embodiments, the present invention relates to compound II, wherein the halogen substituent of R² is iodide that comprises ¹²³I; and the compound has a radioactivity of greater than or equal to about 10 Curie/mmol.

In certain embodiments, the present invention relates to compound II, wherein the halogen substituent of R² is iodide that comprises ¹²³I; and the compound has a radioactivity of greater than or equal to about 100 Curie/mmol.

In certain embodiments, the present invention relates to compound II, wherein the halogen substituent of R² is iodide that comprises ¹²³I; and the compound has a radioactivity of greater than or equal to about 1,000 Curie/mmol.

In certain embodiments, the present invention relates to compound II, wherein the halogen substituent of R² is iodide that comprises ¹²⁴I; and the compound has a radioactivity of greater than or equal to about 1 Curie/mmol.

In certain embodiments, the present invention relates to compound II, wherein the halogen substituent of R² is iodide that comprises ¹²⁴I; and the compound has a radioactivity of greater than or equal to about 5 Curie/mmol.

In certain embodiments, the present invention relates to compound II, wherein the halogen substituent of R² is iodide that comprises ¹²⁴I; and the compound has a radioactivity of greater than or equal to about 10 Curie/mmol.

In certain embodiments, the present invention relates to compound II, wherein the halogen substituent of R² is iodide that comprises ¹²⁴I; and the compound has a radioactivity of greater than or equal to about 100 Curie/mmol.

In certain embodiments, the present invention relates to compound II, wherein the halogen substituent of R² is iodide that comprises ¹²⁴I; and the compound has a radioactivity of greater than or equal to about 1,000 Curie/mmol.

In certain embodiments, the present invention relates to compound II, wherein the halogen substituent of R² is iodide that comprises ¹²⁵I; and the compound has a radioactivity of greater than or equal to about 1 Curie/mmol.

In certain embodiments, the present invention relates to compound II, wherein the halogen substituent of R² is iodide that comprises ¹²⁵I; and the compound has a radioactivity of greater than or equal to about 5 Curie/mmol.

In certain embodiments, the present invention relates to compound II, wherein the halogen substituent of R² is iodide that comprises ¹²⁵I; and the compound has a radioactivity of greater than or equal to about 10 Curie/mmol.

In certain embodiments, the present invention relates to compound II, wherein the halogen substituent of R² is iodide that comprises ¹²⁵I; and the compound has a radioactivity of greater than or equal to about 100 Curie/mmol.

In certain embodiments, the present invention relates to compound II, wherein the halogen substituent of R² is iodide that comprises ¹²⁵I; and the compound has a radioactivity of greater than or equal to about 1,000 Curie/mmol.

In certain embodiments, the present invention relates to compound II, wherein the halogen substituent of R² is iodide that comprises ¹³¹I; and the compound has a radioactivity of greater than or equal to about 1 Curie/mmol.

In certain embodiments, the present invention relates to compound II, wherein the halogen substituent of R² is iodide that comprises ¹³¹I; and the compound has a radioactivity of greater than or equal to about 5 Curie/mmol.

In certain embodiments, the present invention relates to compound II, wherein the halogen substituent of R² is iodide that comprises ¹³¹I; and the compound has a radioactivity of greater than or equal to about 10 Curie/mmol.

In certain embodiments, the present invention relates to compound II, wherein the halogen substituent of R² is iodide that comprises ¹³¹I; and the compound has a radioactivity of greater than or equal to about 100 Curie/mmol.

In certain embodiments, the present invention relates to compound II, wherein the halogen substituent of R² is iodide that comprises ¹³¹I; and the compound has a radioactivity of greater than or equal to about 1,000 Curie/mmol.

In certain embodiments, the present invention relates to compound II, wherein R¹ represents independently for each occurrence aryl.

In certain embodiments, the present invention relates to compound II, wherein R¹ represents independently for each occurrence optionally substituted phenyl.

In certain embodiments, the present invention relates to compound II, wherein R¹ represents independently for each occurrence phenyl.

In certain embodiments, the present invention relates to compound II, wherein R² is halogen-substituted aryl.

In certain embodiments, the present invention relates to compound II, wherein R² is halogen-substituted phenyl.

In certain embodiments, the present invention relates to compound II, wherein R¹ represents independently for each occurrence phenyl and R² is 4-fluorophenyl.

In certain embodiments, the present invention relates to compound II, wherein A is halide, acetate, nitrate, sulfonate, phosphonate, valerate, oleate, palmitate, stearate, laurate, or benzoate.

In certain embodiments, the present invention relates to compound II, wherein A is halide, acetate, or nitrate.

In certain embodiments, the present invention relates to compound II, wherein A is nitrate.

In certain embodiments, the present invention relates to compound II, wherein R¹ represents independently for each occurrence phenyl, R² is 4-fluorophenyl, and A is nitrate.

In certain embodiments, the present invention relates to compound II, wherein R¹ represents independently for each occurrence phenyl, R² is 4-iodophenyl, and A is nitrate.

In one aspect, a method for making a radiohalogenated compound comprises the steps of a) obtaining a reactant and a radiohalogenating agent; b) forming a reaction mixture comprising the reactant and the radiohalogenating agent; and c) contacting the reaction mixture with microwave radiation to achieve a temperature of between 100° C. and 250° C. for a time sufficient to convert at least 10% of the reactant into the desired radiohalogenated compound having the formula (II).

In one embodiment, the reactant has the formula of

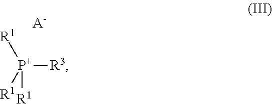

wherein
R¹ represents independently for each occurrence aryl or heteroaryl;
R³ is selected the group consisting of nitro-substituted aryl, nitro-substituted aralkyl and nitro-substituted alkenyl (C₂-C₂₀); and
A is an anion that has an overall charge of −1.

A may be any anion as discussed above or any other anion as appreciated by one skilled in the art.

In one embodiment, R³ is selected the group consisting of amine-substituted alkyl (C₁-C₂₀), amine-substituted cycloalkyl (C₃-C₁₀), amine-substituted aryl, amine-substituted aralkyl and amine-substituted alkenyl (C₂-C₂₀). In one preferred embodiment, R³ is amine-substituted aryl.

In one embodiment, R³ is selected the group consisting of halogen-substituted alkyl (C₁-C₂₀), halogen-substituted cycloalkyl (C₃-C₁₀), halogen-substituted aryl, halogen-substituted aralkyl and halogen-substituted alkenyl (C₂-C₂₀). In one preferred embodiment, R³ is halogen-substituted aryl.

In one embodiment, R³ is selected the group consisting of sulfonate-substituted alkyl (C₁-C₂₀), sulfonate-substituted cycloalkyl (C₃-C₁₀), sulfonate-substituted aryl, sulfonate-substituted aralkyl and sulfonate-substituted alkenyl (C₂-C₂₀). In one preferred embodiment, R³ is sulfonate-substituted aryl.

In one embodiment, R³ is selected the group consisting of acetate-substituted alkyl (C₁-C₂₀), acetate-substituted cycloalkyl (C₃-C₁₀), acetate-substituted aryl, acetate-substituted aralkyl and acetate-substituted alkenyl (C₂-C₂₀). In one preferred embodiment, R³ is acetate-substituted aryl.

In one embodiment, the radiohalogenating agent has a formula of R′—F,
wherein
R′ is selected from the group consisting of an alkali metal cation, an alkaline earth metal cation, a transition metal cation, an ammonium cation, and a tetralkylammonium cation, and
F is a fluoride anion, such as ¹⁸F⁻.

In one preferred embodiment, R′ is selected from the group consisting of an alkali metal cation, an ammonium cation, and a tetralkylammonium cation. More preferably, R′ is an ammonium cation.

In one embodiment, the radiohalogenating agent has a formula of R′—I,
wherein
R′ is selected from the group consisting of an alkali metal cation, an alkaline earth metal cation, a transition metal cation, an ammonium cation, and a tetralkylammonium cation, and
I is an iodide anion, such as ¹²³I⁻, ¹²⁴I⁻, ¹²⁵I⁻, or ¹³¹I⁻.

In one preferred embodiment, R′ is selected from the group consisting of an alkali metal cation, an ammonium cation, and a tetralkylammonium cation. More preferably, R′ is an ammonium cation.

In one embodiment, a radiohalogenating agent may include any compound or substance that can provide halogen with radio active isotope as discussed above.

In one embodiment, the present method for producing a radiohalogenated compound may include one additional step of pre-treatment of the reactant and the radiohalogenating agent to remove base before microwave irradiation. As discussed above, a radiohalogenating agent may be treated in an ammonium hydroxide preconditioned cartridge (e.g., Sep-Pak QMA light cartridge; 1% ammonium hydroxide followed by sterile water) and subsequently eluted from the cartridge with 1 mL of a 1% solution of ammonium hydroxide/acetonitrile solution (20/80).

In one embodiment, Applicants note there is a decrease in yield to less than 10% and in most cases 1-2% when using the an unconditioned column. This is because more sodium bicarbonate or potassium carbonate counterion is released from the anion exchange column which decomposes the starting material. Ideally no anion exchange column should be used from trap-and-release of the F-18 anion but this is not practical due to the volume of water from the cyclotron target. In one embodiment, the smallest the anion exchange column works best (i.e., Fluoride MP-1 from MedChem Imaging).

In one embodiment, the reactant and the radiohalogenating agent may be mixed to a reaction mixture with or without a solvent. When there is a solvent in the mixture, any solvent as discussed above may be used.

After the reaction mixture forms, the reaction mixture may contact microwave irradiation to achieve a sufficient temperature for a time sufficient to convert at least 10% of the reactant into at least one desired radiohalogenated compound.

In one embodiment, the microwave power is between 100 W and 600 W. In one embodiment, the microwave power is between 120 W and 500 W. In one embodiment, the microwave power is between 150 W and 400 W. In one embodiment, the microwave power is between 170 W-300 W. In one embodiment, the microwave power is between 180 W and 250 W. In one embodiment, the microwave power is about 200 W. In one embodiment, the microwave power is so selected that a desired temperature can be reached.

In one embodiment, the temperature is between 100° C. and 250° C. In one embodiment, the temperature is between 120° C. and 220° C. In one embodiment, the temperature is between 140° C. and 210° C. In one embodiment, the temperature is between 150° C. and 190° C. In one preferred embodiment, the temperature is between 160° C. and 180° C. In one more preferred embodiment, the temperature is about 170° C.

In one embodiment, the reaction time of the present microwave-assisting method is significantly less than that in the catalytic radiofluorination. In one embodiment, the reaction time is less than 10 minutes, preferably less than 5 minutes, more preferably about 2 minutes.

In some embodiments, the present method significantly increases the yields of the radiohalogenated compound.

In one embodiment, the yield of the radiohalogenated compound is at least 10%.

In one embodiment, the yield of the radiohalogenated compound is at least 15%.

In one embodiment, the yield of the radiohalogenated compound is at least 20%.

In one embodiment, the yield of the radiohalogenated compound is at least 30%.

In one embodiment, the yield of the radiohalogenated compound is at least 40%.

In one embodiment, the yield of the radiohalogenated compound is at least 50%.

In one embodiment, the present method may include additional step of purification. Applicants envision that any purification method as appreciated by one skilled in the art may be used in the present invention. In one specific embodiment, the purification step uses a high-performance liquid chromatography (HPLC) method. The Example shows the detail information of HPLC purification.

Another aspect of the present invention relates to a formulation, comprising a radiohalogenated compound as disclosed herein and a pharmaceutically acceptable excipient. Applicants' previous patent and applications (such as US 2005/0260130, U.S. Pat. No. 7,632,485 and EP 2610234) disclose examples of formulations and pharmaceutically acceptable excipients.

The following examples are, of course, offered for illustrative purposes only, and are not intended to limit the scope of the present invention in any way. Indeed, various modifications of the invention in addition to those shown and described herein will become apparent to those skilled in the art from the foregoing description and the following examples and fall within the scope of the appended claims.

### EXAMPLES

This invention relates to specific radiolabeling production of activated and non-activated aromatic molecules. In some embodiments, yield improvements of nucleophilic substitution of specific activated aromatic molecules are claimed.

Radiofluorination automation of 4-nitrophenyltriphenylphosphonium nitrate for producing 18F-flurophenyltriphenylphosphonium cation using anhydrous ¹⁸F fluoride produced by trapping in a basic solution, results in 1-2% yield. Changing the radiofluorination reaction by increasing temperature and reaction time as well as changing solvent does not increase yield. The existing production yield makes this drug distribution and utility unfeasible.

Here, we claim methods and conditions for increasing the yield of this radiofluorination to over 30% at the end of the reaction. The improved methods include improvement in anion exchange cartridge trapping and releasing of cyclotron produced ¹⁸F-fluoride followed by its anhydrous formation. The new method eliminates use of bases such as potassium carbonate, resin bound bicarbonate, tetraalkyl ammonium bicarbonate and Kryptofix 2.2.2., and employs microwave heating and selected solvent and reaction times.

In one embodiment removal and purification of the ¹⁸F-fluoride and its anhydrous production condition are important for yield improvement. In another embodiment, controlling the trapping base of the cyclotron produced ¹⁸F-fluoride is critical to the yield improvement. In another embodiment, the use of microwave, sealed reaction vessel and reaction time is crucial to the yield improvement. In another embodiment, the yield increase of ¹⁸F-FTPP is claimed. In another embodiment, radofluorination of other activated and non-activated aromatic molecules are claimed.

### Example 1

F-18 Labeled Tracer and Methods of Manufacture

Here we report on a drug with high potential use as a blood flow agent for the diagnosis of heart disease. 4-[¹⁸F]Fluorophenyltriphenylphosphonium ion (FTPP or BFPET) exhibits optimal characteristics as a PET imaging perfusion tracer due to its significant heart uptake and kinetics. This lipophilic cationic compound is a radiofluorinated analog of tetraphenylphosphonium cation (TPP+) and concentrates in mitochondria having a negative inner transmembrane potential (1-4). The data obtained indicate that FTPP is useful for quantitative in vivo PET measurement of blood flow and determination of cell membrane potential. The values observed agree with that measured with tetraphenylphosphonium in a working Langendorff rat heart model (4). Animal studies in rabbits and monkeys illustrated the valuable use of this agent. Phase I safety, dosimetry and heart pharmacokinetic evaluation of FTPP in normal subjects have been completed.

Unfortunately, the current procedure used to produce FTPP for clinical studies gives a very low yield of the tracer and eliminates its potential clinical use. The current procedure is as follows: ammonium hydroxide (100 μL) is added to [¹⁸F]fluoride (1.5 mL) in water and the vial is heated at 120° C. under a nitrogen stream at partial vacuum for 20 minutes. 4-Nitrophenyltriphenylphosphonium nitrate (6-8 mg) in 1 mL of acetonitrile is added and the vial is heated at 120° C. for 13 minutes to dryness. The reaction mixture is heated at 210° C. for 10 minutes and then cooled to room temperature. Purification is performed by HPLC (Phenomenex, Luna, C18, 10 mm, 250×10 mm) operating in a binary gradient mode at room temperature. The mobile phase consists of solvent A, (PBS) and solvent B, (35:65, ethanol:PBS). Initial mobile phase conditions (100% solvent A) at a rate of 5 mL/min for 5 min, followed by a step gradient to solvent B maintained at a rate of 5 mL/min for the final product separation (Rt=17-19 min). The collected fraction is heated at 100° C. under partial vacuum and nitrogen gas flow for 13 minutes to remove solvent. [¹⁸F]FTPP is formulated in saline and filtered (0.22μ GP Millex). Synthesis is completed within two hours; yield of [¹⁸F]FTPP was 925 MBq (25 mCi) (3.3% EOS). HPLC analysis (Waters Bondapak C18, 4.6×150 mm column; flow: 1 mL/min, acetonitrile/20 mM ammonium formate, 50:50, v/v, rt=8.5 min) showed a chemical and radiochemical purity of 98% or greater.

Several attempts made using Kryptofix 2.2.2 or tetrabutylammonium bicarbonate to increase the yield by changing solvents, temperatures (Table 1), and reaction time were not successful.

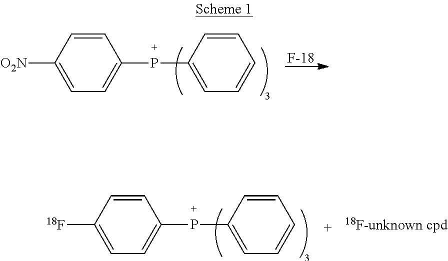

TABLE 1
Reaction Summary for different solvents, temperatures and microwave irradiation

| | Conditions | Yield^{a} | Comment |
|---|---|---|---|
| Jul. 9, 2009 | Kryptofix/120° C./DMSO | no product | 1.8% unk cpd |
| Dec. 16, 2003 | NH₄OH/200° C./no solvent | 16% product | 1% unk cpd |
| Dec. 3, 2003 | CuSO₄/200° C./no solvent | 20% product | 1% unk cpd |
| Nov. 4, 2003 | Kryptofix/200° C./DMSO | 1% product | 80% unk cpd |
| Oct. 28, 2003 | Kryptofix/200° C./sulfone | 1% product | 40% unk cpd |
| Oct. 15, 2003 | Kryptofix/200° C./DMSO | 1% product | 75% unk cpd |
| Oct. 12, 2003 | Kryptofix/160° C./DMSO | no product | 15% unk cpd |
| Oct. 16, 2003 | TBA-bicarb/120° C./DMSO | no product | 10% unk cpd |
| May 5, 2013 | NH₄OH/200° C./DMSO | 23% product | <1% unk cpd |
| May 5, 2013 | NH₄OH/210° C./DMSO | 15% product | <1% unk cpd |
| May 5, 2013 | NH₄OH/180° C./DMSO | no product | 1% unk cpd |
| May 5, 2013 | NH₄OH/200° C./DMF | no product | 1% unk cpd |
| Jun. 16, 2013 | microwave100 W/150° C./DMSO | no product | |
| Jun. 17, 2013 | microwave100 W/200° C./DMSO | no product | |
| Jun. 17, 2013 | microwave200 W/150° C./DMSO | 20% product | |
| Jun. 17, 2013 | microwave200 W/170° C./DMSO | 50% product | |

^{a}Yields are in percent F-18 incorporation, not isolated

Here we report new reaction conditions and methods for improvement of FTPP and a series of compounds similar such as 4-fluorophenyltriphenyl ammonium ion and 4-fluorophenyltriphenyl sulphonium ion. Yield improvements of these drugs require several production changes to allow potential commercialization of the radiofluorinated drugs for PET imaging.

In particular, we discovered that radiofluorination of FTPP is sensitive to small amounts of base in the reaction mixture such as Kryptofix 2.2.2 and potassium bicarbonate used for complexation of F-18 anion (Table 1). As well as from the method of ion exchange trap and release of the radiofluoride which introduce trace amounts of base. Heating the reaction mixture in presents of these bases results in drug decomposition, and hence low labeling yields.

The following lists the required change for yield improvement:

1. The present ¹⁸F- trap and release method is different.

2. Use of microwave.

3. Reaction time is shortened by an order of magnitude (2 minutes versus 10 to 20).

4. Purification conditions.

The new synthesis changes are presented in the following Table 2.

TABLE 2
The New Synthesis Changes

| | Current method | New method |
|---|---|---|
| F-18 trap and | Untreated anion | Anion exchange |
| release method | exchange cartridge | cartridge is pretreated |
| | releases potassium | with 10% ammonium |
| | bicarbonate along | hydroxide solution |
| | with F-18 | followed by water. |
| Reaction | 210° C. | 170° C. |
| conditions | | |
| temperature | | |
| Reaction | 10-20 min/2 hours | 2 min/45 min |
| time/synthesis | | |
| time | | |
| Solvent | DMSO | DMSO |
| Use of | none | 200 W |
| microwave | | |
| Purification/ | Phenomenex luna | Phenomenex luna |
| HPLC | C- 18, 10 × 250 | C-18, 10 × 250 |
| | mm column, 0% | mm column, 0% |
| | to 35% ethanol in | to 35% ethanol in |
| | PBS, gradient | PBS, gradient |
| Yield | 1-4% | 15-20% |

New Synthesis Summary

4-[¹⁸F]Fluorophenyltriphenylphosphonium ion was prepared from the nitro precursor by microwave-induced nucleophilic [¹⁸F]fluorination. A solution of [¹⁸F]fluoride in target water (2.3 mL) was isolated on an ammonium hydroxide preconditioned Sep-Pak QMA light cartridge (1% ammonium hydroxide followed by sterile water) and subsequently eluted from the cartridge with 1 mL of a 20/80 1% ammonium hydroxide/acetonitrile solution to a microwave vial. Solvent volume was reduced to 100 μL at 110° C. under continuous nitrogen flow concentrated to ˜200 μL at 115° C. under continuous nitrogen flow. 4-Nitrophenyltriphenylphosphonium nitrate (3 mg) in acetonitrile (1 mL) was added to the vial and the drying process continued mixture at 115° C. using additions of acetonitrile (3×0.5 mL). DMSO (200 μL) was added and microwave power was then applied at 200 W maintaining a 170° C. maximum temperature for 2 min. The radiotracer was purified by HPLC (Phenomenex luna C-18 10×250 mm column, 0% to 35% ethanol in PBS, gradient). The product fraction was collected and the ethanol content was reduced to 10% by vacuum and filtered. Synthesis of FTPP was complete within 45 min with a yield of 15-20%, decay corrected.

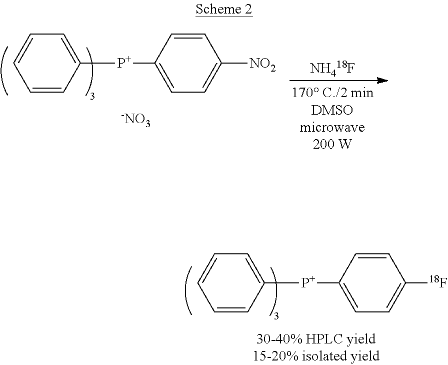

In addition to these types of activated aromatic compounds we claim the use of microwave induced ¹⁸F⁻ fluorination reactions to enhance non-activated aromatic compounds via metal activation. These reactions are low yield and require prolonged reaction time. Microwave reaction of the metal complex with anhydrous ¹⁸F⁻ shortens that time and increase yields. This reaction method will improve many non-activated compounds as described in the following.

Overview

Facilitated Nucleophilic Aromatic Substitution by Metal Complexes.

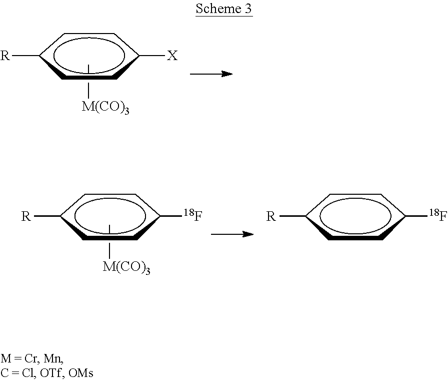

The activation of the aryl group is accomplished by a transition metal and therefore, will not require electron withdrawing groups like cyano, nitro, ester, ketone, aldehydes and the like to allow ¹⁸F⁻ exchange.

### Examples

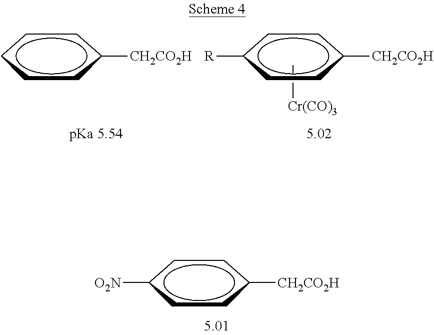

(Benzene)tricarbonylchromium is substantially more electrophilic than benzene, which allows for nucleophilic substitution.

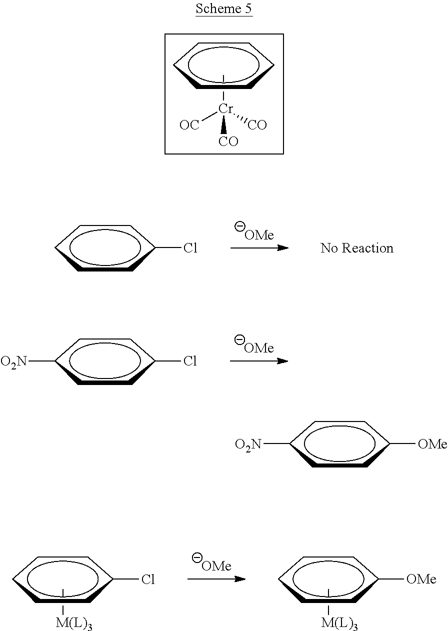

Mechanism:

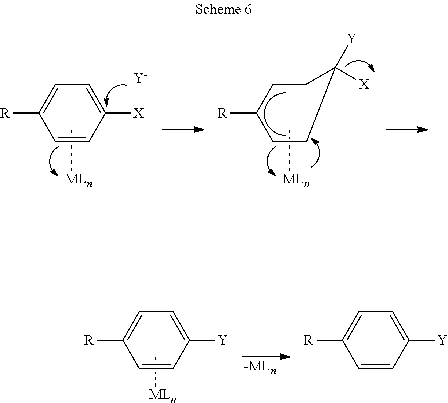

In this case, chromium is the transition metal, X is a leaving group and nucleophile Y is F-18 potassium fluoride or ammonium fluoride; although, in this type of reaction, crown ether such as Kryptofix 222 could be used. We have done an ¹⁸F-exchange of 15-p-iodophenyl-beta-methyl-pentadecanoic acid to give 15-p-[¹⁸F]fluorophenyl-beta-methylpentadecanoic acid using Cr(CO)₆ produced under anhydrous conditions. Also, an exchange reaction was also done with anhydrous fluoride but the yield was low.

In article “Metal-catalyzed halogen exchange reactions of aryl halides” by Tom D. Sheppard [Organic & Biomolecular Chemistry 2009 7(6):1029-1232] it was shown that this catalytic activation with metal catalysis allows halogen exchange. The reactions were done with cold fluorine. The authors are proposing a mechanism as the one we proposed and the transition metals Cr, Mn, Fe can be used.

The following examples were done with molecules without electron withdrawing groups on the aryl unit.

“Novel Chiral 1,3-Diamines by a Highly Modular Umpolung Strategy Employing a Diastereoselective Fluorination—Nucleophilic Aromatic Substitution Sequence” by W. Braun, B. Calmuschi-Cula, U. Englert, K. Höfener, E. Alberico, and Albrecht Salzer.

This reaction is similar to what we did for radiofluorination. The aryl is actually has electron donating groups which deactivate the ring but nucleophilic substitution still occurs.

Diastereospecific Electrophilic Ortho-Fluorination

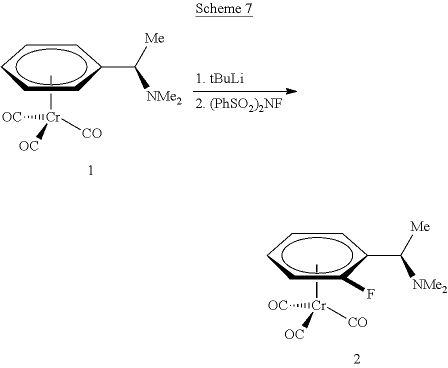

Liberation of the Ortho-Fluorinated Benzylamine

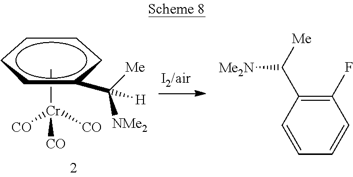

### Example 2

Evaluation Of Ftpp (Ftpp), A Novel F-18 Labeled Tracer For Myocardial Perfusion Imaging, In Coronary Artery Disease Subjects.

Introduction

4-[¹⁸F]Fluorophenyltriphenylphosphonium ion (FTPP) exhibits optimal characteristics as a PET imaging perfusion tracer due to its significant heart uptake and kinetics. This lipophilic cationic compound is a radiofluorinated analog of tetra phenylphosphonium cation (TPP+) and concentrate in mitochondria having a negative inner transmembrane potential (Shoup T M, Elmaleh D R, Hanson R N, Fischman A J. Fluorine-18 and iodine-125 labeled tetraphenylphosphonium ions as potential PET and SPECT imaging agents for tumors. JNM, 2004,45:447; Shoup T M, Elmaleh D R, Brownell A-L, Zhu A, Guerrero L J, Fischman A J. Evaluation of (4-[18F]fluorophenyl)triphenylphosphonium Ion. A Potential Myocardial Blood Flow Agent for PET. JNM 2005:461; Shoup T M, Elmaleh DR, Brownell A-L, Zhu A, Guerrero L J, Fischman A J. Evaluation of (4-[18F]fluorophenyl)triphenylphosphonium Ion. A Potential Myocardial Blood Flow Agent for PET. Molecular Imaging & Biology, 2011,13:511-517; Gurm G S, Danik S B, Shoup T M, Weise S, Takahashi K, Laferrier S, Elmaleh D R, Gewirtz H. 4-[18F]Fluorophenyltriphenylphosphonium: A PET Tracer for Measurement of Myocardial. Cardiovascular Imaging, 2012, 5(3):285-92). The data obtained indicate that FTPP is useful to quantitative in vivo PET measurement of ΔΨm. The values observed agree with that measured with tetraphenylphosphonium in a working langendorff rat heart model (4). Animal studies in rabbits and monkeys illustrated that the valuable use of this agent. Phase I safety, dosimetry, and heart pharmacokinetic evaluation of FTPP in normal subjects have been completed.

One of the objectives of this study: the PET image properties of FTPP as a myocardial perfusion agent were evaluated in patients with stable coronary artery disease (CAD).

Methods

Patients with stable CAD were included in a 3 day study protocol. Safety endpoints included vital signs, 12 lead ECG and clinical laboratory tests. Imaging was performed with Siemens Biograph 64 PET/CT scanner and imaging entailed a CT for positioning, attenuation measurement and evaluation of coronary artery anatomy (day-1). This was followed by baseline and post-adenosine SPECT imaging with ^{99m}Tc Sestamibi. On day 2, 10 mCi of FTPP was administered followed by a second 10 mCi dose of FTPP and PET/CT imaging.

### Example 3

Synthesis of FTPP

Ammonium hydroxide (100 μL) was added to ¹⁸F fluoride (1.5 mL) and the vial was heated at 120° C. under a nitrogen stream at partial vacuum for 20 minutes. 4-Nitrophenyltriphenylphosphonium nitrate 3 mg in 1 mL of acetonitrile was added and the vial was heated at 120° C. for 13 minutes to dryness. The reaction mixture was heated to 210° C. for 10 minutes, cooled to room temperature and purified by HPLC (35:65, ethanol:PBS). The collected fraction was heated at 100° C. under partial vacuum and nitrogen gas flow for 13 minutes to remove solvent. ¹⁸F-FTPP was formulated in saline and filtered (0.22μ GP Millex). Synthesis was completed within two hours, yield of ¹⁸F-FTPP was 925 MBq (25 mCi)(3.3% EOS). HPLC analysis (Waters Bondapak C18, 4.6×150 mm column, flow: 1 mL/min, acetonitrile/20 mM ammonium formate, 50:50, v/v, rt=8.5 minutes) showed a chemical and radiochemical purity of 98% or greater.

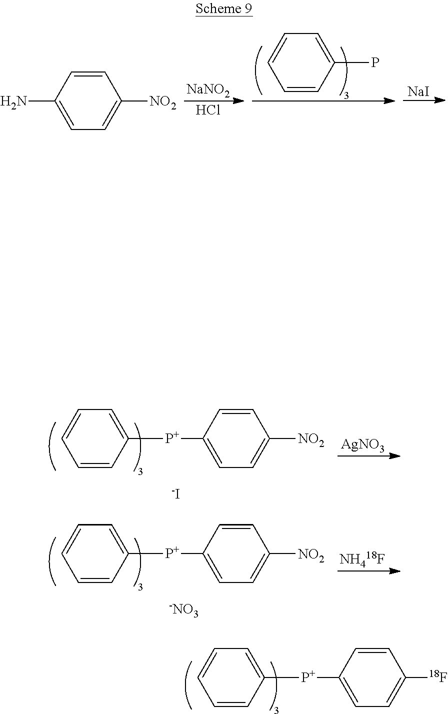

Results

PET studies with FTPP and SPECT studies with ^{99m}Tc Sestamibi were similarly effective in detecting areas of reversible myocardial perfusion, however, due to the higher imaging resolution, apparent thinning throughout ventricle was observed and lesions were more defined in the PET studies. The findings with FTPP were verified with CTA. In some cases, the areas of hypoperfusion imaged with FTPP, after adenosine injection, were also present in the baseline with blood flow in six subjects.

### CONCLUSION

These preliminary findings in patients with stable CAD confirmed that FTPP has excellent blood flow imaging properties, rapid extraction from blood, stable heart uptake over time and high target-to-background ratios. FTPP has a convenient imaging window within 30 minutes of injection and heart imaging with FTPP may be achieved with low dose (˜6 mCi). FTPP is a safe and effective agent for obtaining high resolution myocardial blood flow imaging.

Thus, while the invention has been described above in connection with particular embodiments and examples, the invention is not necessarily so limited, and that numerous other embodiments, examples, uses, modifications and departures from the embodiments, examples and uses are intended to be encompassed by the claims attached hereto. The entire disclosure of each patent and publication cited herein is incorporated by reference, as if each such patent or publication were individually incorporated by reference herein.

We claim:

1. A method of producing a radiofluorinated compound, comprising
a) forming a reaction mixture comprising a reactant having the formula of R—Y and a radiofluorinating agent having the formula of R′—¹⁸F; and
b) contacting the reaction mixture with microwave radiation to achieve a temperature of between 100° C. and 250° C. for a time sufficient to convert at least 10% of the reactant into the radiofluorinated compound having the formula of R—¹⁸F,
wherein:
R is selected from the group consisting of an aryl, a heteroaryl, an aralkyl (C₁-C₂₀) and an alkenyl group (C₂-C₂₀);
Y is selected from the group consisting of a sulfonate, a nitro, an acetate and a halogen; and
R′ is selected from the group consisting of an alkali metal cation, an alkaline earth metal cation, a transition metal cation, an ammonium cation, and a tetraalkylammonium cation.

2. The method of claim 1, wherein R is an aryl or a heteroaryl group.

3. The method of claim 2, wherein R is an aryl group.

4. The method of claim 3, wherein R is an aryl group having the formula of 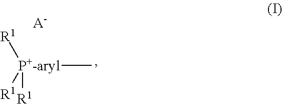
wherein:
R¹ represents independently for each occurrence aryl or heteroaryl; and
A is an anion that has an overall charge of −1.

5. The method of claim 4, wherein R¹ is a phenyl and A is a nitrate.

6. The method of claim 1, wherein Y is a nitro.

7. The method of claim 1, wherein R′ is an ammonium cation or a tetraalkylammonium cation.

8. The method of claim 7, wherein R′ is an ammonium cation.

9. The method of claim 1, wherein the method further comprises a step of purification.

10. (canceled)

11. (canceled)

12. (canceled)

13. The method of claim 1, wherein the reaction time is less than 10 minutes.

14. (canceled)

15. (canceled)

16. The method of claim 1, wherein the yield of the radiofluorinated compound is at least 10%.

17. (canceled)

18. (canceled)

19. The method of claim 1, wherein the method further comprises a step of pretreating the radiofluorinating agent and the reactant to remove base before microwave irradiation.

20. A method for producing a radiohalogenated compound having the formula of 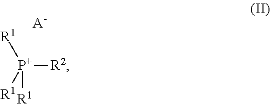
wherein:
R¹ resents independently for each occurrence aryl or heteroaryl;
R² is halogen-substituted aryl, halogen-substituted aralkyl (C₁-C₂₀), or halogen-substituted alkenyl (C₂-C₂₀); wherein said halogen substituent is fluoride that comprises ¹⁸F, or said halogen substituent is iodide that comprises ¹²³I, ¹²⁴I, ¹²⁵I, or ¹³¹I; and
A is an anion that has an overall charge of −1, comprising
a) obtaining a reactant and a radiohalogenating agent;
b) forming a reaction mixture comprising the reactant and the radiohalogenating agent; and
c) contacting the reaction mixture with microwave radiation to achieve a temperature of between 100° C. and 250° C. for a time sufficient to convert at least 10% of the reactant into the desired radiohalogenated compound.

21. The method of claim 20, wherein the reactant has the formula of 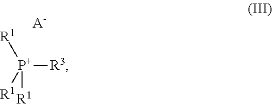
wherein:
R¹represents independently for each occurrence aryl or heteroaryl;
R³ is selected from the group consisting of nitro-substituted aryl, nitro-substituted aralkyl (C₁-C₂₀) and nitro-substituted alkenyl (C₂-C₂₀); and
A is an anion that has an overall charge of −1.

22. The method of claim 20, wherein the radiohalogenating agent has a formula of R′—F,
wherein
R′ is selected from the group consisting of an alkali metal cation, an alkaline earth metal cation, a transition metal cation, ammonium cation, and tetralkylammonium cation, and
F is a fluoride anion.

23. (canceled)

24. (canceled)

25. The method of claim 20, wherein the reaction time is less than 10 minutes.

26. (canceled)

27. (canceled)

28. The method of claim 20, wherein the yield of the radiohalogenated compound is at least 10%.

29. (canceled)

30. (canceled)

31. The method of claim 20, wherein the method further comprises a step of purification.

32. (canceled)

33. The method of claim 20, wherein the method further comprises a step of pretreating the reactant and the radiohalogenating agent to remove base before microwave irradiation.
